(19) United States
(12) Patent Application Publication
(10) Pub. No.: US 2003/0175032 A1
(43) Pub. Date: Sep. 18, 2003

(54) Planar device having an IIR tapped delay line for multiple channel dispersion and slope compensation

(76) Inventor: Eliseo R. Ranalli, Irvine, CA (US)

Correspondence Address: CORNING INCORPORATED, SP-TI-3-1, CORNING, NY, 14831

(21) Appl. No.: 10/098,881

(22) Filed: Mar. 15, 2002

(51) Int. Cl. H04B 10/00

(52) U.S. Cl. 398/147; 398/161

(57) ABSTRACT

The invention consists of an apparatus or device for compensating for the chromatic and/or polarization mode dispersion of light waves in an optical communication system, and a method of using the device. The device is a feedback device wherein the feedback loop has a plurality of optical paths, and each of said optical paths has associated therewith a delay element which imparts a predetermined delay to a signal propagating through the optical path. The couplers/splitters in the device are configured to split an incoming optical signal among the plurality paths according to predetermined splitting ratios and to recombine the signal that have been delayed with incoming optical signal. The delays and splitting ratios may be predetermined and chosen to effect a specific change to said spectral profile.

### FIELD OF THE INVENTION

This invention relates generally to optical filters; and in particular to a planar device having a tapped delay line constituting an infinite impulse response filter for correcting chromatic dispersion.

### BACKGROUND OF THE INVENTION

Light pulses, traveling through an optical fiber, can spread out with time due to the different wavelengths constituting the pulse traveling at different speeds (chromatic dispersion) or different polarization states of the wavelengths constituting the pulse traveling at different speeds (polarization mode dispersion). Chromatic dispersion is actually the sum of material dispersion and waveguide dispersion. Material dispersion arises due to variations in the refractive index of the core material, which in turn causes different wavelengths to travel at different speed. Waveguide dispersion arises because a portion of the light also travels in the cladding material overlying the core. Because the cladding material has a different refractive index than the core material, light travels through the cladding at different speed than it travels through the core.

Polarization mode dispersion arises from the spreading out of the electric and magnetic fields associated with the light that travels through an optical fiber. Although the electric and magnetic fields of each light wavelength are generally randomly oriented, they can be separated into vertical and horizontal components-the polarization states. If these polarization states travel through a perfectly straight length of perfectly cylindrical optical fiber, the states would all travel at the same speed and would arrive at the end of the fiber at the same time. Polarization mode dispersion is a random effect that arises from slight flaws occurring along the length of the optical fiber, or from stress points (random or constant) which may occur at bends in the fiber. These flaws and stresses can cause the polarization states to travel at different speeds. When the states reach the end of the fiber, they will be slightly separated in time and thus cause the light pulses to be spread out.

The use of infinite impulse response (“IIR”) filter structures for correcting chromatic dispersion has been used in two devices currently known in the art. Due to the long temporal reach of these structures, optical signals occupying several signaling intervals can be interfered in a manner which will produce a very wavelength-dependent delay. This delay will effectively minimize post-filtered signal components (wavelengths) not occupying the intended signal interval and will thus reduce intersymbol interference.

In the first type of device, fiber Bragg gratings (“FBG”) are used for fixed dispersion compensation. In this method the grating period is varied along the length of the fibers (“chirped”) so that the wavelengths which experience the longest delays in the transmission fiber will see the shortest delays in the FBG. As a result, all wavelengths within a given wavelength division multiplexing (“WDM”) channel see more-or-less a common delay in the serial combination. This method also has a limited degree of tunability that can be achieved by heating the structure or by perturbing the index of refraction of the channel materials by some other means. While this type of device is simple and inexpensive, it has some serious problems. Small imperfections within the fiber optical channels can lead to very large ripples in the wavelength-dependent group delay and/or the polarization dependence. 3M™ Telecommunications offers dispersion compensation devices of this type under the name 3M Pulse Compressor.

In the second type of device, a virtually-imaged phased array (“VIPA”), such as the one with limited tunability marketed by Avanex (Fremont, Calif.), can be used to compensate for chromatic dispersion. The filtering element in this device is basically a Fabry-Perot resonator with a clear input aperture that creates a virtual-image phased array. While this device does essentially what a grating does, there is a difference in that the delay corresponding to consecutive virtual images is much greater than the delay caused by an ordinary Bragg grating. As a result, the structure has a larger angular dispersion and effectively gives rise to hundreds or even thousands of diffraction orders. Examples of the VIPA devices can be found in U.S. Pat. Nos. 6,301,048, 6,296,361, 6,266,170, 6,185,040, 6,169,828, 6,169,630, 6,144,494 and 6,028,706.

Although both of the above devices and techniques can compensate for chromatic and/or polarization mode dispersion, they suffer from a limited ability to separately set the desired transmission and dispersion characteristics. Accordingly, it is an object of the present invention to provide a device that, in addition to compensating for chromatic and/or polarization mode dispersion, allows one to specify the wavelength dependent transmission and also arbitrarily assign as many derivatives of the phase (or equivalently, as many orders of dispersion) as may be desired.

### SUMMARY OF THE INVENTION

The invention consists of an apparatus or device for compensating for the chromatic and/or polarization mode dispersion of light waves in an optical communication system, and a method of using the device. The device is a feedback device wherein the feedback loop has a plurality of optical paths, and each of said optical paths has associated therewith a delay element which imparts a predetermined delay to a signal propagating through the optical path. The couplers/splitters in the device are configured to split an incoming optical signal among the plurality paths according to predetermined splitting ratios and to recombine the signal that have been delayed with incoming optical signal. The delays and splitting ratios may be predetermined and chosen to effect a specific change to said spectral profile.

### BRIEF DESCRIPTION OF THE DRAWINGS

FIG. 1 illustrates 2-tap embodiment of the chromatic dispersion compensating device of the invention.

FIG. 2 illustrates an m-tap embodiment of the chromatic dispersion compensating device of the invention, where m is an integer greater than 1.

FIG. 3 illustrates the simulated filter response using a 2-tap IRR dispersion compensation device of the invention.

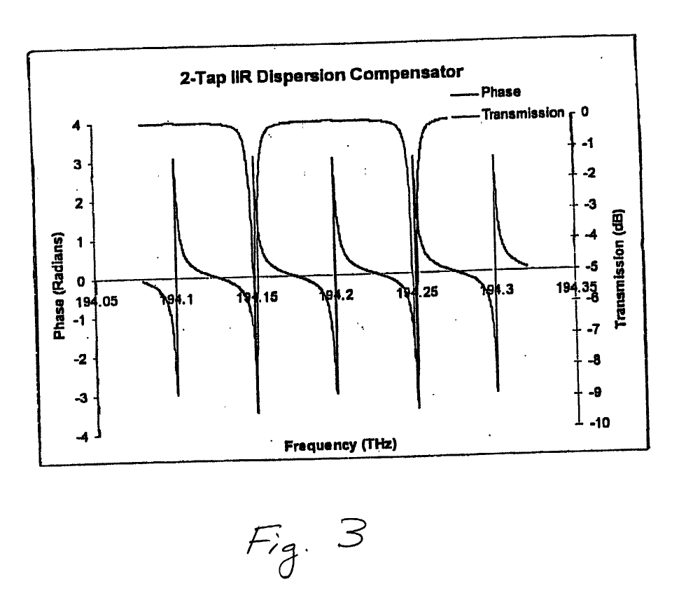

### DETAILED DESCRIPTION OF THE INVENTION

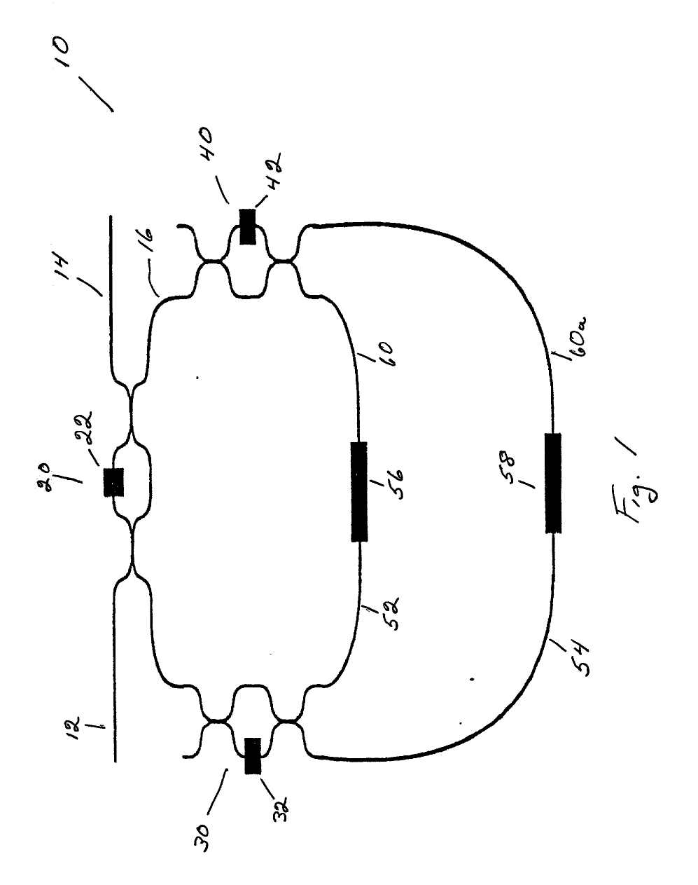

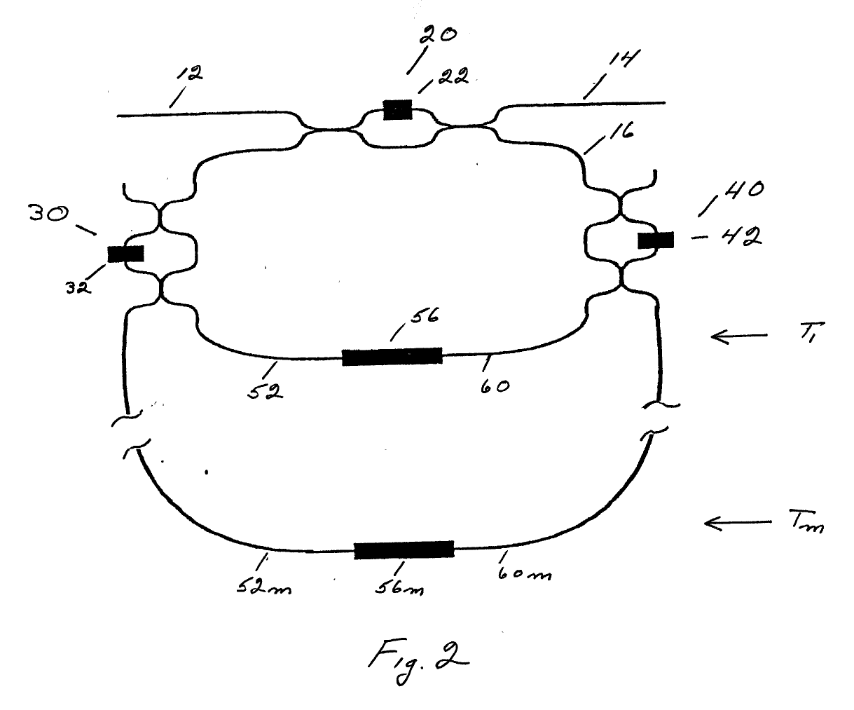

The invention is an auto-regressive, moving average (“ARMA”) filter as illustrated in exemplary manner by FIG. 1. While the device of FIG. 1 is a 2-tap filter, a device having any number of taps as illustrated by FIG. 2, can be made and used in accordance with the invention. For example, when used with an optical fiber transmitting a single wavelength, a two tap filter may be sufficient to compensate for the wavelength or wavelength band being used. If a plurality of wavelengths or wavelength bands is being used, the number of taps may be increased according to the number of wavelengths or wavelength bands that are to be compensated. For example, if two wavelengths are being transmitted in a single fiber, it may be desirous to use a 4-tap device, with a pair of taps being directed to each of the specific wavelengths. The selection of the number of taps is at the discretion of the user. An embodiment of the invention having “m” number of taps, where m is an integer greater than 1, is shown in FIG. 2, with elements 52m, 56m and 60m corresponding to elements 52, 56 and 606.

Generally, the device comprises a first input waveguide carrying an optical signal to a first coupler/splitter where the signal strength or energy is divided into two parts at some pre-selected percentage or ratio; for example, 90/10, 65/35, 50/50, etc. One part is transmitted to a first output waveguide for further transmission and the other part is fed to a waveguide serving as the input waveguide to a delay loop comprising a plurality of additional coupler/splitters, a plurality of waveguides and a plurality of heating or other elements which are useful or necessary to impart a delay to the signal, or various wavelengths comprising the signal, in the loop. The delay loop can be by-passed by setting the first splitter/coupler so that there is not signal splitting and all of the input signal is fed directly to output waveguide.

After processing in the delay loop, the signal are then fed to a delay loop output waveguide which in turn feeds into the input side of the first coupler/splitter where delay loop processed signal is mixed with a signal from the first input waveguide. Regarding the first coupler/splitter, signals are continuously fed to and received from the delay loop. The mixing of the delayed signal and “fresh” input signal from the first input waveguide gives rise to an interference which cancels the chromatic and/or polarization mode dispersion present in the first input signal.

Referring now to FIG. 1, the device contains waveguides 12 and 14, either of which can serve as the input waveguide, the other being the output waveguide. For purposes of illustration, waveguide 12 is selected as the input waveguide and waveguide 14 as the output waveguide. The device, as illustrated, also contains Mach-Zendler (“MZ”) structures 20, 30 and 40, each of which are actively configurable by means of heating units, typically resistance heaters, 22, 32 and 42, located on one arm of the MZ structure and illustrated as shaded rectangular structures.

The delay paths 52 and 54 have different lengths of waveguide/fiber. The waveguides present in delay paths 52 and 54 may be waveguides which have an altered index of refraction, as compared to each other and to waveguides 12 and 14, throughout all or part of their length. Altering the index of refraction in a waveguide changes the effective optical path length through that waveguide, thereby effecting a delay in signal propagation time, and phase, through that waveguide. The alteration in refractive index can be a permanent alteration, inherent in the waveguide, or it can be a temporary or reversible alteration. An example of making a permanent alteration is to subject all or a selected portion of the waveguide to UV radiation. For a temporary or reversible alteration, the refractive index would be selectively modified to achieve the desired delay in propagation by the use, for example, of heating elements 56 and 58, respectively, which are used to perturb the delays. Input to the heaters 56 and 58 is by waveguides 60 and 60a. The output of the optical process at any given time is influenced by a very long temporal reach into the history of the output (which reach is infinite in principle), thus spanning many signaling intervals worth of data.

As illustrated, an input signal is supplied to the device through waveguide 12 to the input side of the two-arm, actively configurable MZ coupler/splitter 20. A pre-selected percentage of the original input signal strength is fed from splitter/coupler 20 to output waveguide 14. The remaining percentage of the signal is fed to waveguide 16 that serves as the input waveguide to the delay loop. The signal in waveguide 16 is fed to a second actively configurable MZ coupler/splitter.

If one defines the cos (η) as the amplitude split ratio of the MZ splitter 20, made variable by heater 22 in one arm; the cos (μ) as the corresponding split ratio for the feedback MZs 30 and 40; and T₁ and T₂ as the shortest and longest round trip delays (in seconds) through waveguides 52 and 54, respectively; then the transfer function for the device, as a function of the radian optical frequency ω, is given by the following Equation 1:

$$H ( ω ) = \frac{cos ( η ) + [ {sin}^{2} ( μ ) \cdot {ⅇ}_{1}^{j ω T} - {cos}^{2} ( μ ) \cdot {ⅇ}_{2}^{j ω T} ]}{1 + cos ( η ) \cdot [ {sin}^{2} ( μ ) \cdot {ⅇ}_{1}^{j ω T} - {cos}^{2} ( μ ) \cdot {ⅇ}_{2}^{j ω T} ]} \qquad ( 1 )$$

where j is the imaginary unit (that is, the square root of −1).

Similar expressions can easily be derived in the general case for an arbitrary number of taps (e, g., 1, 2, 3, . . . m). Because the transfer function has both numerator and denominator, polynomial functions of the complex exponential e^{jωT}_{m,} where m is the number of taps, it is classified as being both auto-regressive (“AR”, meaning non-zero denominator coefficients) and moving average (“MA”), meaning non-zero numerator coefficients). Consequently, the device is ARMA. The polynomial coefficients, the magnitudes of which give the sine and cosine squared values and the phases of which determine the delay perturbations, can be determined using a linear least mean square (“LMS”) error algorithm. The frequency response vector (“v”) and the matrix (“M”) for the LMS computations are shown given in Equations 2 and 3, respectively.

v=ΣH(ω)·exp[j·ω·T−t] (2)

M=Σexp[j·ωT·] (3)

where: t=taps=0 . . . (taps−1); T=delay time in seconds; exp=e; and the other symbols are as stated above.

In an example of the invention, it was desired to realize a filter with unity transmittance at the centers of the ITU (International Telecommunications Union) grid while simultaneously providing −1 rad/GHz (approximately 125 rad/nm) worth of dispersion at the center wavelengths. While the filter of the invention is capable of much more dispersion, the most likely use of the invention will be for trimming the dispersion characteristics beyond the nominal compensation that is provided by a fixed DC (dispersion compensation) module. Such trimming is particularly important for 40 Gbit/sec optical communications, where 40 GHz at such a slope corresponds to a phase shift of ˜80 radians over the bandwidth of the signal. Such a shift would result in severe intersymbol interference if left uncompensated.

In general, since one will desire to provide for the simultaneous compensation of multiple channels of wavelengths, an appropriate sampling interval would be ˜10 psec (the inverse of the ITU channel spacing). This corresponds to a nominal tap (optical path) length of 3 mm. Applying the Equation 1, with cos η arbitrarily chosen as 0.8 (that is, about 64% of the input goes directly to the output and 36% is fed back via the delay loop containing waveguides 52 and 54), gives the result of μ=0.23. The shortest return path is thus lengthened by 7.6 fsec (femtoseconds), relative to a 10 psec less than the longest path. Under these parameters, the device exhibits a response as shown in FIG. 2.

While in FIG. 2 it may appear as though the phase is discontinuous at the channel centers (194.1=n*0.1 THz, where n is an integer), this is in fact simply a consequence of a graphical artifact, namely, phase wrap-around. In fact, the transmission is flat and maximum at this point, and the slopes reach a maximum of −1.1 rad/GHz. By increasing the number of feedback waveguides from the two illustrated in FIG. 1, it is possible to maintain the desired slope over an arbitrarily wide bandwidth, or introduce any other desired dependence in the phase response. Optimization will always be provided by means of the LMS algorithm.

The waveguides, taps and other elements comprising the invention can be made of any material suitable for use in optical communication devices. Examples, without limiting the invention, include silica and polymeric material, as well as other materials known in the art, with and without the presence of dopants and other elements and/or materials selected to impart properties desired for a particular use.

It will be apparent to those skilled in the art that various modifications and variations can be made to the present invention without departing from the spirit and scope of the invention. Thus, it is intended that the present invention covers the modifications and variations of this invention provided they come within the scope of the appended claims and their equivalents.

What is claimed is:

1. An apparatus for the compensation of chromatic and/or polarization mode dispersion of light waves in an optical communication system, said device comprising:
a plurality of optical paths, each of said optical paths having associated therewith a delay element which imparts a predetermined delay to a signal propagating through the optical path; and
a plurality of couplers/splitters configured to split an incoming optical signal among said plurality paths according to predetermined splitting ratios and to recombine signals that have been delayed;
wherein said predetermined delays and predetermined splitting ratios are chosen so as to effect the desired change to said spectral profile.

2. The apparatus according to claim 1, wherein the delay element in an optical path is a waveguide has an index of refraction different from the index of refraction of other waveguide materials present in the device.

3. The apparatus according to claim 2, wherein the index of refraction of the delay element in an optical path is reversible changeable.

4. The apparatus according to claim 3, wherein the delay element is heated by a resistance heater to thereby change the index of refraction of the element.

5. The apparatus according to claim 1, wherein the coupler/splitters are Mach-Zendler elements having a resistance heater on one arm thereof.

6. The apparatus according to claim 5, wherein the resistance heater of each coupler/splitter is independently controllable.

7. A method for compensating for the chromatic and/or polarization mode dispersion of light waves in an optical communication system, said method comprising:
providing, from an input waveguide, an input light signal to a splitter/coupler to thereby split the strength of said signal into two parts in a predetermined ratio;
sending one part of said split signal to an output waveguide;
sending the second part of said signal to delay path top impart a delay to said signal; and
combining the signal coming from said delay path with input signal to thereby compensate for the chromatic and/or polarization mode dispersion present in said input signal; and
sending said combined signals to an output waveguide.

8. The method according to claim 7, wherein the second signal is split into a plurality of signals by one or a plurality of coupler/splitters to split said signal into a plurality of parts, and each of said split signals is sent to a separate delay element to have a delay imparted to said signal, and said delayed signals are recombined before being combined with the input signal.
